(19) United States
(12) Patent Application Publication
(10) Pub. No.: US 2005/0085964 A1
(43) Pub. Date: Apr. 21, 2005

(54) Network coupled diagnosis and maintenance system

(76) Inventors: Benjamin P. Knapp, Byron Center, MI (US); Emilio Banchs Fabregat, Portage, MI (US)

Correspondence Address: Clifford Kraft, 320 Robin Hill Dr., Naperville, IL, 60540, US

(21) Appl. No.: 10/690,426

(22) Filed: Oct. 21, 2003

(51) Int. Cl. G06F 19/00

(52) U.S. Cl. 701/33; 701/29; 340/438

(57) ABSTRACT

A system for correcting problems in a vehicle maintenance system that includes a local computer in communication via a network with a remote computer. The remote computer can transmit a diagnostic to the local computer with the local computer returning diagnostic data from running the diagnostic. The remote computer can contain a decision algorithm that uses the diagnostic data to determine a correction for the problem and send the correction to the local computer. The system can also include a database at the remote computer where the database can contain histories of previous alignment system problems. The database can also contain service histories for particular maintenance system as well as solutions to past problems. Finally the database can also contain component information for all maintenance systems in the field.

### BACKGROUND

1. Field of the Invention

The present invention relates to the general field of maintenance and more particularly to a remote diagnostic and maintenance system that uses a network such as the Internet to provide remote diagnostics and services to a plurality of wheel alignment locations or other maintenance locations.

1. Description of the Prior Art

It is known in the art of vehicle wheel alignment to attach alignment heads to vehicle wheels where these heads are in communication with a local computer that performs alignment calculations and displays alignment data on a screen to a technician. The same is known in the art of engine analysis.

In addition, it is known to allow the local computer to communicate with one or more remote computers over a network that can be a private network or the Internet. In fact, the remote computer can in some cases provide the alignment calculations rather than the local computer. In addition, the results of the alignment process can be displayed at the remote computer. An example of this in the wheel alignment art can be found in International Application WO 99/23783 where raw data from wheel alignment sensors is received on a local computer and then transmitted over a network to a remote computer which performs alignment calculations and then returns wheel alignment angles back over the network to the local computer for display to a technician.

It is also known in the art to provide a wheel alignment system or engine analyzer system with sensing devices, sensor interface circuits and a host computer in communication with the sensor interface circuits where the host computer can access other computers over the internet using generalized systems such as dot.NET (or .NET) developed by Microsoft Corporation. An example of this in the wheel alignment art is U.S. Pat. No. 6,442,460 where the host computer can access a plurality of remote software applications using dot.NET. The host computer can provide integrated internet access for transmission of electronic commerce and statistical information, alignment logs, error messages, status messages, or diagnostic information to a remote system, and for the receipt of information including updated software applications, diagnostic commands, and remote information queries.

The prior art, while allowing the communication of diagnostics and data to one or more remote computers, does not teach exactly how problems with wheel alignment systems, engine analyzers or other maintenance systems can be solved by such remote computers. What is badly needed is a system and method for using the Internet to allow a remote service location to diagnose and determine solutions to problems in such systems.

### SUMMARY OF THE INVENTION

The present invention relates to a system for correcting problems in a wheel alignment system, wheel balancing system, engine analyzer system or any other maintenance system that includes at least one local computer in communication via a network with at least one remote computer. The remote computer can transmit one or more diagnostics to the local computer with the local computer returning diagnostic data from running one or more of the diagnostics. The remote computer can contain a decision algorithm that uses the diagnostic data to determine a correction for the problem and send the correction to the local computer. The system can also include a database at the remote computer where the database can contain histories of previous alignment system problems. The database can also contain service histories for particular alignment systems, engine analyzers or other maintenance systems as well as solutions to past problems. Finally the database can also contain component information for alignment systems in the field.

### DESCRIPTION OF THE FIGURES

FIG. 1 shows a block diagram of a maintenance system in communication with a local and remote computer.

FIG. 2 shows a wheel alignment system in communication with a local and remote computer.

FIG. 3 shows a flow chart of a possible diagnostic sequence.

### DESCRIPTION OF THE INVENTION

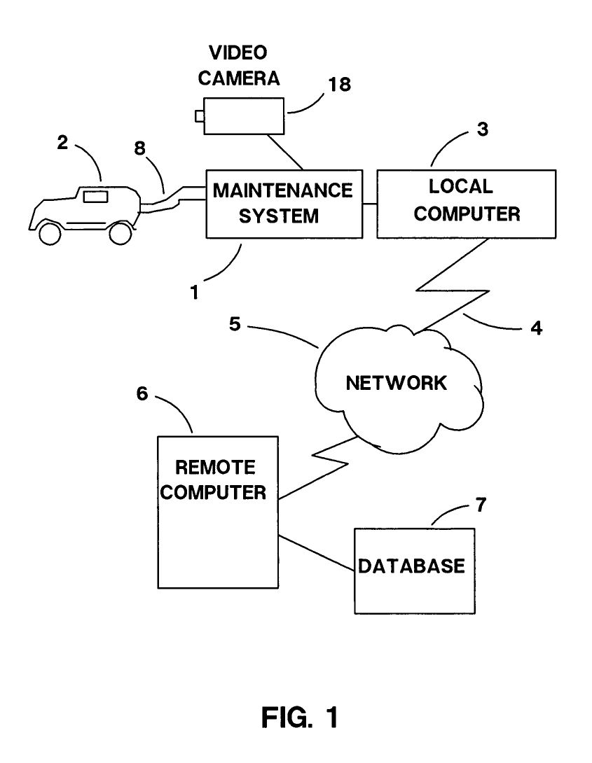

FIG. 1 shows a vehicle maintenance system 1 with various sensors 8 attached to a vehicle. This can be a wheel alignment system, a wheel balancing system, an engine analyzer system, or any other vehicle maintenance system. The maintenance system 1 is generally locally controlled by a local computer 3 that is also coupled through a network 4 into the internet 5, an intranet, LAN or any other type of network. At some remote location a remote computer 6 is able to communicate over the network 4,5 with the local computer 3. The remote computer 6 is also coupled into a database 7.

The system shown in FIG. 1 allows diagnosis and fixing of problems over a network such as the Internet 5 or by any other means of remote communication. When a user of the equipment experiences a problem, that person can activate a troubleshooting program that can possibly determine a corrective action. If the local troubleshooting program cannot fix the problem, communication can be made with a remote computer 6 via the network 4,5.

The remote computer 6 can contain a database 7 that can use a decision tree to perform the diagnosis. This database 7 can be constantly updated to reflect the results of previous cases.

In this manner, the algorithm can “learn” new problems. Of course, a static database could also be employed; however, a static database is not as powerful a dynamic one that is continually being updated with new problems and fixes.

Every maintenance system that leaves the factory can have all of its major elements entered into the database 7. In addition, the entire service history of every such system and each of its components can be recorded in the database 7 and made available to the maintenance algorithm running on the remote computer 6.

In this way, a technician at the remote computer 6 can aid a technician in the field (at the local computer 3) trying to fix a problem. A possible operating scenario is that when a user working with a maintenance system 1 experiences a problem, they can activate a remote service interface program on the local computer (which can be a PC) (the remote service interface program might self-activate upon detecting a problem).

If the local system is authorized (under warranty or service contract), the remote computer 6 or server can download the latest test sequence onto the local computer 3 and call for the local computer 3 to execute it. One of the first tasks for this test sequence would be to make sure that all of the software is up to date with the latest service packs and latest vehicle specifications. If any of those files were out of date, they could be downloaded and installed.

A second possible task could be to perform a checksum against many or all of the executable files in the system to see if there is any program corruption. The remote computer 6 could access the correct checksums for each executable from the data-base 7. Any corrupt software could be replaced (downloaded and installed).

A third possible task could be to execute various hardware test procedures on both the local computer 3 and on maintenance hardware 1 to attempt to detect errors. As an example of this, a communications board might have a loopback switch that could be software activated to test for a bad communications cable. Of course, the nature of the original problem and the decision tree algorithm would determine which hardware tests would be run and in what order.

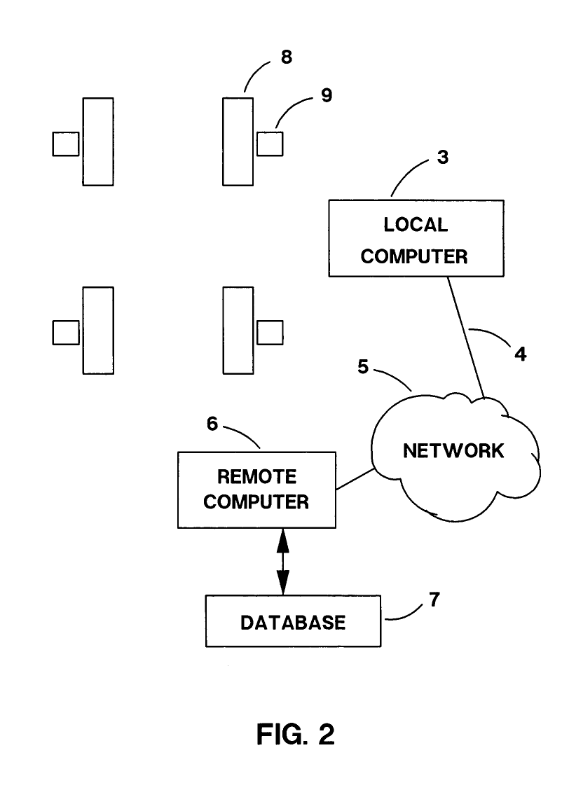

FIG. 2 shows a wheel alignment system that can be maintained using the system and method shown in FIG. 1. Here the four wheels 8 of a vehicle are being aligned using four wheel mounted heads 9 that are in wireless (or cabled) communication with a local PC 3. The PC 3 communicates over a network 4 to the Internet 5 or other network with a remote computer 6 that is in communication with a database 7.

The system and method of the present invention can be used for any type of maintenance system including maintenance systems other than those used with vehicles.

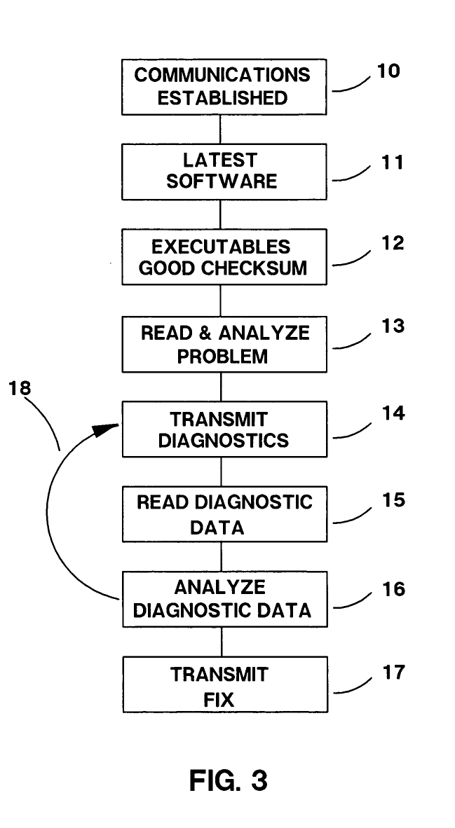

FIG. 3 shows a possible diagnostic sequence at the remote computer. First communication is established 10 with the local computer. The local computer contacts the remote computer to initiate the establishment of communications. Next the local computer is inventoried 11 to determine if the latest software is being used. Next all executables on the local computer are checksummed 12 (or checked for corruption by any other method including checking by 1-1 comparison). Next the problem symptoms are read and analyzed 13. Next the algorithm at the remote computer determines a diagnostic sequence, and that diagnostic sequence is transmitted 14. Next the diagnostic data from the local computer is read 15 and analyzed 16. Here there can be an iterative step 18 where various diagnostics are run, and the data is collected and analyzed. The algorithm could then choose another diagnostic to run (or download and run). Finally the algorithm at the remote computer can choose a fix or course of action and transmit that 17.

The present invention allows diagnosis and repair to take place over a network, in particular over the Internet. Once the problem is diagnosed, a text message and/or video could be displayed at the local computer that could tell the user how to fix the problem. This could include how to replace a defective component or module or certain commands that could be given to local software.

The present invention envisions different fixes in some cases for the same problem. For example, some wheel alignment manufacturers do not want technicians to open a wheel alignment head to replace a board or component. In that case, the entire head would be replaced. On the other hand, a different manufacturer might allow field replacement of boards or components. In this case, the system might direct the user to do that. The system would have these maintenance constraints stored it its database (7 in FIGS. 1 and 2).

In any case, text or video could show a user how to carefully pack a component that was being returned to the manufacturer into a shipping container. In addition, the user may be given a number to include in their packaging (such as a manufacturers RMA number). If a component is field replaceable, a video clip playing on the local computer could show how to open covers and to remove and replace the component. The videos could be pre-stored in the local computer or could be downloaded from the remote computer as needed. Any video technique could be used including known Internet techniques including Flash, AVI, REAL and others.

Field systems can be equipped with an optional video camera (18 FIG. 1). In the case where the decision tree fails to solve the problem, or the problem cannot be solved for some other reason, the user's video camera could be connected over the network to a remote site. Using one-way or two-way live audio/video, the technician at the remote site could interact with the use (over the network) to determine what the correct course of action might be. In addition, the remote technician could have the ability to remotely command the maintenance system to perform various actions and to return various data. For example, in a wheel alignment system, the remote technician could command the left front wheel unit to beep. He could then verify that it beeped by listening to the unit over the live two-way audio/video conference.

The present invention thus provides a convenient way to perform complex field diagnosis and repair of maintenance systems remotely without the necessity of sending out a specialized technician or having the entire system returned to the factory for repair. The ability to store numerous previous problems with similar systems and specific data on the particular system being diagnosed aids the problem considerably.

It was mentioned that an algorithm at a remote computer can provide diagnosis of problems with local systems. In particular, symptoms can be standardized and can be selected from a list of complaints that the user can interactively choose from (in the case a fault was recognized by a user and not by a self-check). Symptoms can be mapped to a specific test relating to that symptom. The result of the test can either lead to another test or a failure code. Once a failure code is reached, the symptom can be deemed diagnosed. The failure code can be mapped to an action code which can be different depending on the distribution channel that the unit was sold through. This process can be repeated until all complaints (symptoms) have been resolved.

There may be results which cause the system to contact the remote service technician.

Some activities (in the diagnostic sequence) may take place regardless of what symptom code/s have been recorded. These activities are currently done first.

1. Some major subsystems include an electronic serial number. This along with the service history of the unit can be used to determine if any hardware needs to be updated. If this is the case a failure code can be logged.

2. Software can checked for necessary updates—if any are needed, a failure code can be logged and the software can be updated.

3. Software can be checked for corrupt files—if any are corrupt they can be replaced and a failure code can be logged.

4. Some subsystems have self tests that can be activated (some may have down-loadable routines while others may have built in routines). Self checks can be activated in any subsystem that has them as long, as the test requires little or no user interaction. Results can be recorded and if a fault is found then failure code can be logged.

After this is done then work can be done on the complaint generated by the end user.

For example:

1. Take first (or next) complaint code and look up corresponding test to perform.

2. Result from test is recorded. This result points to either another test or a failure code.

3. After reaching a failure code we go back to step one and repeat until all complaints have been examined.

4. All failure codes will generate action codes depending on the customer type. Action codes tell customer what to replace and how to replace it or advise customer of proper operation or advise that the problem has been taken care of by virtue of a software update.

As can be seen, the algorithm can be a simple decision tree. It is also possible to use other techniques such as using a “goal based” or “rule based” inference engine.

The present invention has been described using various illustrations and explanations. It should be noted that only example embodiments of the invention have been presented to aid in understanding. It will be recognized by one skilled in the art that many changes and variations can be made and are within the scope of the present invention.

1. A system for correcting problems in a vehicle maintenance system comprising:
a vehicle maintenance system containing at least one local computer, said local computer in communication via a network with at least one remote computer, said remote computer transmitting at least one diagnostic to said local computer, said local computer returning diagnostic data to said remote computer from running said diagnostic;
said remote computer containing a decision algorithm that uses said diagnostic data to determine a correction for said problem, said remote computer returning said correction for said problem to said local computer.

2. The system of claim 1 further comprising a database at said remote computer, said database containing histories of maintenance system problems.

3. The system of claim 2 wherein said database contains service histories for a plurality of maintenance systems.

4. The system of claim 2 wherein said database contains component information for a plurality of maintenance systems.

5. The system of claim 1 wherein said vehicle maintenance system is a wheel alignment system.

6. The system of claim 1 wherein said vehicle maintenance system is an engine analyzer.

7. The system of claim 1 further including maintenance constraints that result in different fixes for different brands of equipment.

8. The system of claim 1 further comprising a video camera in communication with said local computer.

9. The system of claim 8 further comprising live two-way audio/video conferencing between said local computer and said remote computer.

10. The system of claim 1 wherein said decision algorithm is a decision tree.

11. The system of claim 1 wherein said decision algorithm is inference based.

12. A system for correcting problems in a wheel alignment system comprising:
a wheel alignment system containing at least one local computer, said local computer in communication via a network with at least one remote computer, said remote computer transmitting at least one diagnostic to said local computer, said local computer returning diagnostic data to said remote computer from running said diagnostic;
said remote computer containing a decision algorithm that uses said diagnostic data to determine a correction for said problem, said remote computer returning said correction for said problem to said local computer.

13 The system of claim 12 further comprising a database at said remote computer, said database containing histories of alignment system problems.

14. The system of claim 13 wherein said database contains service histories for a plurality of alignment systems.

15. The system of claim 13 wherein said database contains component information for a plurality of alignment systems.

16 The system of claim 12 further including maintenance constraints that result in different fixes for different brands of equipment.

17. The system of claim 12 further comprising a video camera in communication with said local computer, said video cameral allowing live conferencing with said remote computer.

18. A method for performing diagnostics on a maintenance system in the field from a remote location, the method comprising the steps of:
connecting a local computer that is in communication with a maintenance system to a remote computer over a network;
downloading diagnostics over said network to said local computer, said local computer running said diagnostics on said maintenance system
receiving diagnostic data at said remote computer from at least one of said diagnostics, said remote computer analyzing said diagnostic data using a decision tree and a database of previous problems with similar systems;
transmitting a fix from said remote computer to said local computer.

19. The method of claim 18 wherein said maintenance system is a wheel alignment system.

20. The method of claim 18 further comprising the step of storing component information for said maintenance system in said database.

21. The method of claim 18 further comprising using a video camera at said local computer to establish conferencing with said remote computer.

23. The method of claim 21 wherein said conferencing is 2-way audio/video.

24. The method of claim 18 wherein the step of analyzing further comprises using a decision tree.

25. The method of claim 18 wherein the step of analyzing further comprises using a inference based system.
